(19) United States
(12) Patent Application Publication
(10) Pub. No.: US 2021/0192460 A1
(43) Pub. Date: Jun. 24, 2021

(54) USING CONTENT-BASED EMBEDDING ACTIVITY FEATURES FOR CONTENT ITEM RECOMMENDATIONS

(71) Applicant: Microsoft Technology Licensing, LLC, Redmond, WA (US)

(72) Inventors: Junrui Xu, Fremont, CA (US); Qing Duan, Santa Clara, CA (US); Xiaowen Zhang, Santa Clara, CA (US); Xiaoqing Wang, San Jose, CA (US); Benjamin Le, San Jose, CA (US); Aman Grover, San Carlos, CA (US)

(21) Appl. No.: 16/726,547

(22) Filed: Dec. 24, 2019

(51) Int. Cl. G06Q 10/10; G06F 16/9535; G06F 16/9538; G06N 20/00; G06N 5/04

(52) U.S. Cl. CPC G06Q 10/1053; G06F 16/9535; G06N 5/04; G06N 20/00; G06F 16/9538

(57) ABSTRACT

Technologies for leveraging machine learning techniques to present content items to an entity based upon prior interaction history of the entity are provided. The disclosed techniques include identifying a first plurality of content items with which the entity has interacted during prior entity sessions. Interactions include selecting, viewing, or dismissing content items during prior entity sessions. For each content item in the first plurality, a learned embedding is identified, where each of the embeddings represent a vector of content item features mapped in a vector space. An aggregated embedding is generated based on the identified embeddings. A comparison is performed between the aggregated embedding and embeddings corresponding to a second plurality of content items. Based on the comparison, a subset of content items from the second plurality of content items is identified. The subset of content items is then presented on a computing device of the entity.

### TECHNICAL FIELD

The present disclosure relates to machine learning, and more particularly, to identifying a set of embeddings corresponding to content items to recommend for consumption for an entity based upon an aggregated embedding derived from interaction history of the entity with other content items.

### BACKGROUND

Content management systems are designed to provide content items to users for consumption. Content items may represent content such as photos, videos, job posts, news articles, documents, user ports, audio, and many more. Content management systems may implement various machine learning models to assist in determining which content items to present to users based upon delivery objectives of the content providers. For example, content delivery objectives may be optimized to deliver job post content items to users in order to maximize the probability that users will interact with the job post.

The machine learning models are trained to select content items that satisfy the delivery objectives based upon attributes of content items and attributes of the target users. A machine learning model may select content item job posts that have job attributes that are similar to a user's profile attributes. For instance, if a user's profile attributes indicate that the user is a software engineer specializing in web services, then the machine learning models may identify several job posts that are directed to web service software engineer jobs. These machine learning models may perform well when a user's profile attributes accurately reflect the user's job seeking intention. However, in many cases, a user may seek jobs that do not directly align with their current job and their current user profile attributes. For example, if a user wishes to change their career or their current industry, then conventional machine learning models may not accurately provide content item job posts that interest the user if the content item job posts selected are based on the user's current employer and/or current user profile attributes.

Conventional machine learning approaches for content item selection may also inadequately present content item job posts to a user if the user's profile information is out of date. This may occur if the user chooses not to update their user profile due to privacy concerns even though the user is very active during user sessions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment.

FIG. 2 depicts a block diagram of a software-based system for generating embeddings for content items, aggregating embeddings, determining and scoring relationships between embeddings, and recommending a set of content items to present to an entity for consumption, in an embodiment.

FIG. 3 depicts an example of clusters of job opportunity content items graphed on a principal component analysis plot, in an embodiment.

FIG. 4 depicts an example of determining similarities between entity-based aggregated embeddings and available job opportunity content item embeddings, in an embodiment.

FIG. 5 depicts an example flowchart for generating an aggregated embedding representing an ideal job opportunity for an entity and identifying a set of content items, for presentation, that are similar to the ideal job opportunity for the entity, in an embodiment.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As disclosed herein, presenting relevant content items related to job opportunities to an entity is improved by adding technology that implements a particular approach of identifying entity interactions with content items related to job opportunities and using the entity interactions to identify a new set of content items that are closely related to the content items that the entity previously interacted with. In one technique, a machine-learned model is used to map content items related to job opportunities in a vector space. Embeddings for each job opportunity are then determined.

A content management system may be implemented to allow entities, such as users, to initiate entity sessions for the purpose of consuming content items. For example, a user may log into the content management system to search for job opportunities, view content items related to job opportunities, to apply to various job opportunities, and so on. During an entity session, the content management system may track entity interactions with various content items. For instance, the content management system may keep track of job opportunity content items that the entity applied to, searched for, viewed, and even dismissed. In an embodiment, a first plurality of content items, representing job opportunities, are identified for the entity based upon interactions tracked during entity sessions. For each content item, in the first plurality of identified content items, the content management system may identify embeddings learned by the machine-learned model. Each of the embeddings may contain feature values that refer to various aspects of the job opportunities. For example, an embedding for a particular job opportunity may be based on the job type, the job title, a required level of experience, the company associated with the job opportunity, the company size, the industry, the location, and so on.

In an embodiment, the content management system may aggregate the embeddings for each of the first plurality of content items to generate an aggregated embedding. The aggregated embedding may represent an ideal or preferred job opportunity based upon job opportunities that the entity previously interacted with. For instance, if the entity is Jane Doe and during various entity sessions Jane Doe searched for, viewed, and applied to several software engineer job opportunities, then the aggregated embedding may represent an ideal job opportunity derived from Jane Doe's interactions with the several software engineer job opportunities.

In an embodiment, the content management system may perform a comparison between the aggregated embedding and a second plurality of content items, where the second plurality of content items represents other job opportunities that the entity has yet to interact with during an entity session. Since the aggregated embedding represents a vector, within a vector space provided by the machine-learned model, and the second plurality of content items represents job opportunities previously mapped to embeddings within the same vector space, the content management system may compare embeddings using vector distances between the aggregated embedding and each of embeddings representing the content items in the second plurality of content items. Upon comparing embeddings of each of the content items to the aggregated embedding of the entity, a subset of content items may be identified as being similar to the aggregated embedding of the entity. The subset of content items represents job opportunities that are similar to the ideal job opportunity generated for the entity based upon the entity's interaction history with the first plurality of content items. The content management may then present the subset of content items to the entity when requested. For example, during a subsequent entity session, when the entity requests a list of job opportunities, the content management system may present the content items that closely align with the entity's job preference based upon their previous entity session activity.

The disclosed approaches describe content items in the context of job opportunities. However, the present disclosure is not limited to only job opportunities and may apply to other types of content items, such as news stories, documents, advertisements, entity posts, audio/video content items, as well as photos.

This approach to learning entity preferences based upon prior entity interactions with other content items improves selection and presentation of relevant of job opportunities to the entity based upon the entity's interaction history over selecting job opportunities based upon matching entity criteria determined by static entity features, such as entity properties defined in an entity profile. Since entity profile information may remain static until an entity updates the profile information, job opportunity selection is improved by incorporating entity interaction history to determine entity preferences related to current job opportunities. As a result, entities may be able to view more relevant job opportunities that more closely align with current entity session behavior.

### System Overview

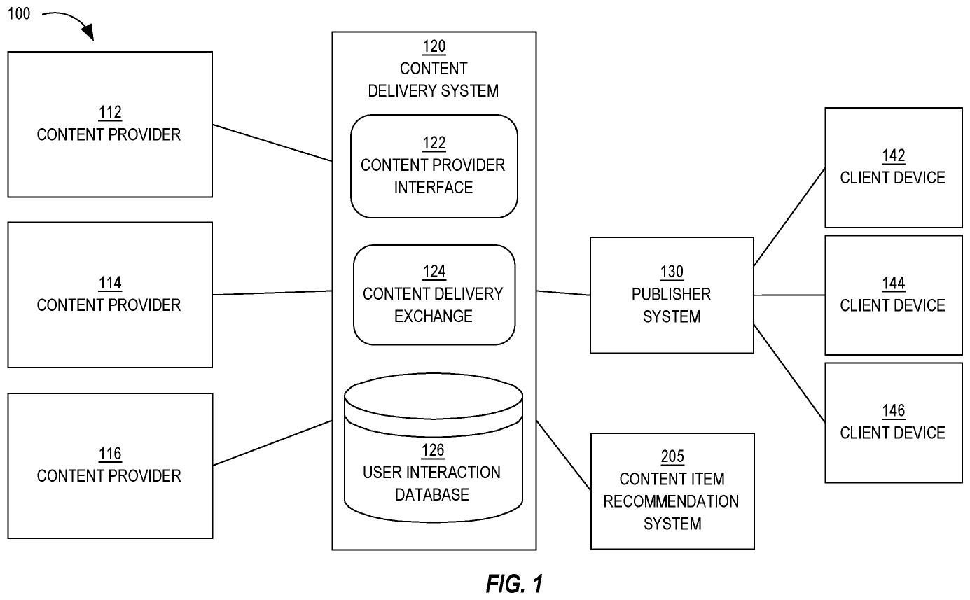

FIG. 1 is a block diagram that depicts a system 100 for distributing content items to one or more end-users, in an embodiment. System 100 may represent all or part of a content management system. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

In an embodiment, the content delivery system 120 may fulfill content item requests by requesting a recommended set of content items from a content item recommendation system 205. The content item recommendation system 205 is a system that implements a machine-learned model to generate embeddings for content items based upon features associated with the content items. For example, if the content item request is a request for job opportunity content items suitable for a requesting entity, then the content item recommendation system 205 may implement a machine-learned model that generates embeddings for job opportunity content items and uses the model to determine a set of job opportunity content items that are similar to the requesting entity's job preference. The requesting entity's job preference may be determined from entity interactions within entity sessions, entity profile attributes, and any other attributes associated with the entity that may be used to determine the requesting entity's job opportunity preference.

The content item recommendation system 205 is not limited to one specific content item type, and may be implemented to provide a set of content items based upon a requested content item type. Content item types, may include, but are not limited to, news stories, sports, finance, traveling, other entities, advertisements, photos, audio/videos, and any other type of content item. For example, the content delivery system 120 may receive a request to provide a set of news story content items that the requesting entity may be interested in. The content delivery system 120 may send the request to the content item recommendation system 205, where the content recommendation system 205 is implemented to provide a recommended set of news story content items that are relevant to the entity based on the entity's news preference.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In some embodiments, in response to receiving a content request, content delivery exchange 124 may initiate a content item selection event that involves selecting one or more content items (from among multiple content items) to present to the client device that initiated the content request. An example of a content request may be a request to display available job opportunities, where the content item selection event may involve requesting one or more job opportunity content items for a specific entity. Optionally, content item selection event may involve an auction. For example, if the content items requested represent advertisements, then the content item selection event may represent an advertisement auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content items, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a content item that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126. Logging such events allows content delivery system 120 to track how well different content items and/or campaigns perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, a click data item may indicate a particular content item, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item. From click data items and impression data items associated with a content item, content delivery system 120 may calculate a CTR for the content item.

### Embeddings

An embedding is a vector of real numbers. “Embedding” is a name for a set of feature learning techniques where words or identifiers are mapped to vectors of real numbers. Conceptually, embedding involves a mathematical embedding from a space with one dimension per word/phrase (or identifier) to a continuous vector space.

One method to generate embeddings includes implementing a machine learned model. In the context of linguistics, word embedding, when used as the underlying input representation, have been shown to boost performance in natural language processing (NLP) tasks, such as syntactic parsing and sentiment analysis. Word embedding aims to quantify and categorize semantic similarities between linguistic items based on their distributional properties in large samples of language data. The underlying idea that a word is characterized by “the company it keeps.”

In an embodiment, in the context of job opportunity content items for selection, an embedding is learned for each of the content items that represent job opportunities and for each of the entities registered in the content management system. Entities may correspond to users of the content management including user profiles associated with each user. Values representing the job opportunity content items as well as the entities in the content management system may be string values, numeric identifiers, or integers. For instance, a job opportunity content item may correspond to a software engineer job opportunity at LinkedIn and values of the job opportunity content item may include string values such as the job title, the company name, or an integer value such as a job identifier code, such as “54321” which uniquely identifies the job opportunity.

In an embodiment, embeddings for job opportunity content items are learned through a separate process and not based on training data that is used to train the machine learned model. For example, an embedding for each content item in a graph of connected content items is learned using an unsupervised machine learning technique, such as clustering. In such a technique, an embedding for a content item is generated/learned based on embeddings for content items to which the particular content item is connected in the graph. The graph may represent a network graph of job opportunities and their respective attributes. Example attributes of job opportunities may include job title, job industry, job function, skills, company, company size, required degrees and/or certifications, and other any other relevant job attributes. A connection may be created for a pair of job opportunities based on similarities between job opportunity attributes.

### Content Item Recommendation System

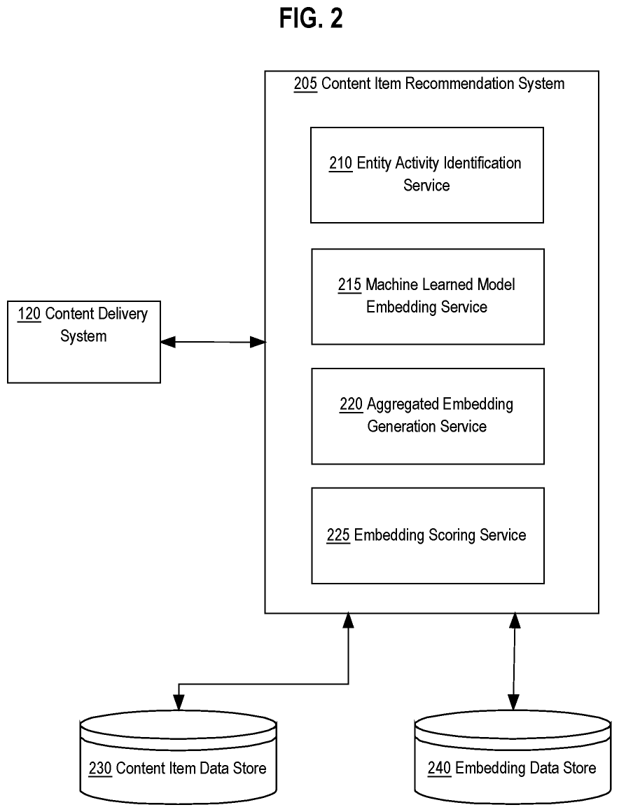

FIG. 2 depicts a block diagram of an example software-based system for generating embeddings for content items, generating aggregated embeddings, determining and scoring relationships between embeddings, and recommending a set of content items to present to an entity for consumption. Content items may represent different types of content. For example, types of content may include, but are not limited to, advertisements, news stories, documents, entities, entity posts, audio/video content, photos, as well as job opportunities. The disclosure is described using job opportunity type content items. However, the systems and processes described may apply to any other content item type, such as advertisements. For instance, content provider 112 may create a content delivery campaign to deliver advertisement content items to target entities. The content item recommendation system 205 may select and provide, to the content delivery system 120, a set of recommended advertisement content items based on the interaction history of the target entities.

In an embodiment, a content item recommendation system 205 implements an entity activity identification service that identifies specific interactions of entities during entity sessions in order to associate entity interaction behavior with corresponding content items. The entity interaction behavior may be used to identify the content items of a specific type that a particular entity has interacted with for the purposes of generating an aggregated embedding that represents an ideal type of content item for the particular entity based upon the particular entity's interaction history. For example, the entity activity identification service may be implemented to identify specific interactions related to job opportunity content items, where the interactions may include when an entity selects a job opportunity content item, applies for a job presented by a job opportunity content item, and/or dismisses a job opportunity content item.

In an embodiment, the content item recommendation system 205 implements a machine-learned model that graphs embeddings for job opportunity content items. The machine-learned model may be used to determine embeddings of job opportunity content items that are similar to an ideal job for an entity based on vector distances within a vector space. An “ideal job” may be represented using a synthesized embedding that is an aggregate of embeddings from multiple job opportunity content items with which the entity has positively interacted. The content item recommendation system 205 implements services to determine a set of job opportunity content items to recommend for presentation to the entity based on their proximity in the vector space to the aggregated embedding, which represents the entity's “ideal job”.

In an embodiment, the content item recommendation system 205 may be communicatively coupled to the content delivery system 120 for the purposes of receiving requests for content item recommendations and providing to the content delivery system 120 the content item recommendations for delivery to client devices 142-146. In an embodiment, the content item recommendation system 205 may be communicatively coupled to content item data store 230 and embedding data store 240. The content item data store 230 may represent data storage implemented to store content items, such as job opportunity content items. For example, the content item data store 230 may store currently posted job opportunities as well as job opportunities that have already been fulfilled. The content item data store 230 may store content items retrieved from various sources, including the content providers 112-116. Alternatively, the content item data store 230 may store references, such as links, to content items provided by the content providers 112-116. The content item recommendation system 205 may retrieve content items from the content item data store 230 for the purposes of identifying a corresponding embedding as well as to retrieve specific content items recommended to the content delivery system 120.

In an embodiment, the embedding data store 240 may represent data storage implemented to store embeddings associated with content items as well as aggregated embeddings determined for entities. Additionally, the embedding data store 240 may store embedding score values that describe how similar or related a job opportunity content item is to an aggregated embedding associated with a particular entity.

In an embodiment, the content item recommendation system 205 may include an entity activity identification service 210, a machine-learned model embedding service 215, an aggregated embedding generation service 220, and an embedding scoring service 225. In an embodiment, the entity activity identification service 210 retrieves entity interaction data, from the user interaction database 126, identified as specific interactions with different job opportunity content items. For example, if a user initiates a new user session and during that user session, the user searches for job opportunities and selects a first and second job opportunity content item for viewing, then the actions related to viewing the first job opportunity content item may be identified as interactions associated with the first job opportunity. If, for the second job opportunity content item, the user applies for the job, then the interactions of viewing and applying for the second job opportunity content item will be associated with the second job opportunity content item. In an embodiment, the entity activity identification service 210 may periodically or on-demand retrieve entity interaction data from the user interaction database 126 in the content delivery system 120.

### Machine Learned Model Embedding Service

The machine-learned model embedding service 215 is implemented to generate and train the machine-learned model to map embeddings representing job opportunity content items within a vector space. In one embodiment, the machine-learned model may be a regression model, such as a linear regression model, where input into the model includes features of a job opportunity content item. The output from the model is a representative embedding of the job opportunity content item based on the features received. One technique for implementing the machine-learned model is by using a neural network, such as Word2vec, to produce embeddings for the job opportunity content items based on descriptive features in the job opportunity description. Word2vec is a commercially available deep learning model that implements word embedding configured to generate vector representations of words that capture the context of the word, semantic and syntactics properties of the word, and relations to other words.

In another embodiment, the machine-learned model may be implemented using a Generalized Linear Mixed model. A Generalized Linear Mixed model is a linear regression model that incorporates fixed effects as well as random effects. The Generalized Linear Mixed model described in the present disclosure adds new entity-level regression models to the generalized linear model, which provides personalized job opportunity recommendations for entities based upon their activity. Entity activity may refer to interactions that an entity has had with various job opportunity content items, for example, selecting the job opportunity content item, applying for job opportunities, or dismissing presented job opportunity content items.

The fixed effects are used to identify global matches between features of job opportunity content items and features of entity profiles, such as entity profile attributes. The fixed effects represent non-random features such as known features of job opportunity content items, entity profile attributes, as well as entity interaction activity. For example, job opportunity content item features may include job title, company, industry, job location, job skills, and any other identifiable job feature. Entity profile attributes may include attributes associated with an entity's current and past employment, education, and other relevant skills or certifications.

Random effects may represent various latent features of job opportunity content items and/or entity profile attributes with respect to entity interaction history. Latent features represent hidden features associated with the job opportunity content items and/or entity profile attributes. The random effects for such latent features may be identified using training data that includes subsets of content items identified by a set of common features. For instance, a set of the top-K most frequent member profile features may be used to identify a subset of content items for training the model to identify the job-level random effects. These top-K features may include, but are not limited to, industry, job function, education history, skills and so forth. Similarly, a set of the top-K most frequent job features may be used to identify a subset of content items for training the model to identify the member-level random effects. The top-K features may include features such as job title, keywords in the job description, required skills and qualifications, and any other notable job features. The random effects are used to identify preferences of a specific entity based upon different job opportunity content item features and different entity features. Specifically, the random effects in the Generalized Linear Mixed model may be used for predicting a probability that a specific entity may apply for a job opportunity based on interactions the specific entity has had with various job opportunity content items, including but not limited to, selecting the job opportunity content item, applying for the job opportunity, or dismissing the job opportunity.

In an embodiment, the machine-learned model may be based on a two-tower embedding model that represents embeddings for job opportunity content items and entity embeddings within a vector space. A two-tower embedding model is a machine-learned model that employs two feature networks, or towers, that are connected to a comparison network with a constraint that the two towers share the same parameters. For example, one tower may be based upon features from job opportunity content items, while the other tower may be based upon features extracted from entity profile attributes. Embeddings are generated for both the job opportunity content items as well as the entity profile attributes. Each of the embeddings are compared to derive similarities between job opportunities and entity profile attributes. Implementing a two-tower embedding model may be beneficial to address cold start issues for new entities, where there is no prior entity interaction history. For example, when a new user joins the content management system, the system does not have any entity interaction history for the new user because the new user has not previously initiated an entity session. As a result, the content item recommendation system may not be able to recommend job opportunity content items based on prior interaction history. The two-tower embedding model may be used to initially determine a set of recommended job opportunity content items by using embeddings based upon entity profile attributes.

In an embodiment, training data for the described machine-learned models may comprise entity attributes, job opportunity content item features, and label data that indicates whether a specific entity applied for or dismissed a specific job opportunity. Examples of entity attributes may include current and prior job titles, current and prior employers, employer industries, degrees and certifications, and any other entity profile attributes. Examples of job opportunity content item features include job title, company, industry, department, job location, job skills, degree and certification requirements, and any other relevant features. The training data is used to identify embedding features that may be used to cluster similar job opportunities together. Using training data that includes labels indicating job opportunities that entities either applied to or dismissed, the machine-learned model may identify two-tower embeddings (or any other embedding techniques) in a low dimensional space for job opportunity content items. By reducing the overall size of the feature set from approximately 20,000 sparse features to 100-200 dense embedded features, the machine-learned model may reduce the overall processing overhead needed to score and rank job opportunity content items.

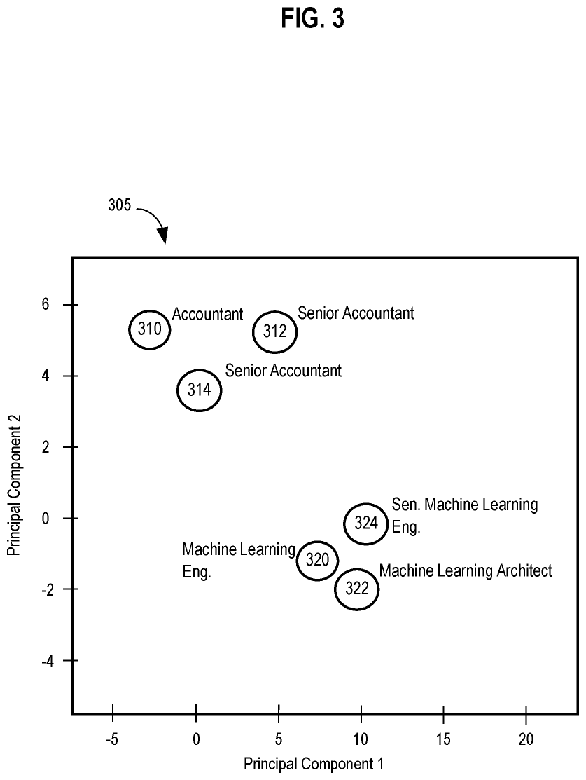

In an embodiment, embeddings representing similar job opportunities in terms of content item features are clustered closer together within the vector space. Examples of content item features used to determine similarities between job opportunities include job title, job skills, and companies. FIG. 3 depicts an example of clusters of job opportunity content items graphed on a principal component analysis (PCA) plot. PCA is a statistical procedure using orthogonal transformation to convert a set of observations of possibly correlated variables into a set of linearly uncorrelated variables called principal components. PCA plot 305 represents a visualization of job opportunity content items clustered in groups based upon their corresponding embeddings. The PCA plot 305 is a two-dimensional graph where the x-axis represents a first principal component (principal component 1) and the y-axis represents a second principal component (principal component 2). Each of the plots 310-322 represent embeddings for specific job opportunity content items. Plot 310 represents an accountant job, plot 312 represents a senior accountant job, and plot 314 represents another senior accountant job. Each of the plots 310, 312, and 314 are clustered together as they represent similar jobs based upon features that make up their corresponding embeddings. Additionally, plot 320 represents a machine learning engineer job, plot 322 represents a machine learning architect job, and plot 324 represents a senior machine learning engineer job. Each of the plots 320, 322, and 324 are clustered together as they represent similar machine learning jobs based upon features that make up their corresponding embeddings, such as industry, company, job title, and required skills.

### Aggregated Embedding Generation Service

In an embodiment, the aggregated embedding generation service 220 generates aggregated embeddings for entities based upon a set of embeddings that are associated with job opportunity content items with which the entity has interacted during an entity session. For example, the entity activity identification service 210 may identify a set of job opportunity content items with which the entity interacted with during one or more entity sessions. The aggregated embedding generation service 220 may take the set of job opportunity content items and request corresponding embeddings for the set of job opportunity content items from the machine-learned model embedding service 215. Alternatively, the machine-learned model embedding service 215 may store embeddings for job opportunity content items in the embedding data store 240, such that the aggregated embedding generation service 220 may retrieve the embeddings for the set of job opportunity content items. Once the corresponding job opportunity embeddings have been retrieved, the aggregated embedding generation service 220 may aggregate the embedding values by applying statistical pooling techniques.

In an embodiment, the aggregated embedding generation service 220 may perform mean pooling, maximum pooling, minimum pooling, and/or any other statistical pooling technique to the values in each of the embeddings retrieved from the machine-learned model embedding service 215. Mean pooling is a technique for calculating average values for each dimension of the vectors that make up the embeddings for which the entity applied. For example, an entity, during one or more entity sessions, may have applied to jobs represented by job opportunity content items, represented by v¹, v², . . . , vⁿ∈ [symbol] ^{d}, where v¹, v², . . . , vⁿ are embeddings for jobs applied to by the entity and [symbol] ^{d} represents the vector space. The mean pooling technique would calculate average values for each dimension for the set of embeddings, mean(v¹, v², . . . , vⁿ), which would represent an aggregated job opportunity embedding based on mean pooling.

Similarly, minimum pooling is a technique for calculating minimum values for each dimension of the vectors that make up the embeddings corresponding to job opportunity content items for which the entity applied. Using the previous example, the minimum pooling would calculate minimum values for each dimension for the set of embeddings, min(v¹, v², . . . , vⁿ), which would represent an aggregated job opportunity embedding based on minimum pooling. The maximum pooling technique is a technique for calculating maximum values for each dimension of the vectors that make up the embeddings for which the entity applied, described as max(v¹, v², . . . , vⁿ). Each of the pooling techniques generate aggregated embeddings that represent an ideal job opportunity for a specific entity. For example, the mean pooling approach generates an ideal job opportunity embedding based on an average of the features that make up job opportunities applied to by the entity. The minimum and maximum pooling approaches generate an ideal job opportunity embeddings based upon extreme feature values from the entity's interaction behavior. For example, if the entity is currently located in San Francisco and subsequently searches for and applies to job opportunities in a completely different geographic location, such as Seattle, then the minimum or maximum pooling approach may capture feature values representing geographic locations that are different from what the entity previously searched or applied to in past entity sessions. Each of the aggregated embeddings represent vectors within the vector space defined by the machine-learned model, such that vₘᵢₙ∈ [symbol] ^{d}, vₘₐₓ∈ [symbol] ^{d}, and vₘₑₐₙ∈ [symbol] ^{d}.

In an embodiment, the aggregated embedding generation service 220 may also generate time-dependent aggregated embeddings that are based upon the amount of time that has passed since an entity interacted with specific job opportunity embeddings. If entity Jane Doe interacted with a first set of job opportunity content items one month ago and a second set of job opportunity content items a couple of days ago, then the aggregated embedding generation service 220 may generate separate aggregated embeddings based upon the amount of time that has passed between interactions. For example, the first set of job opportunity content items may be represented by embeddings (v¹, v², . . . , vⁿ)^{T1}, where T1 indicates a timestamp for the interactions that are one month old and the second set of job opportunity content items may be represented by embeddings (w¹, w², . . . , wⁿ)^{T2}, where T2 indicates a timestamp for the interactions that are two days old. The aggregated embeddings generated, based on mean pooling, may be uₘₑₐₙ^{T1} and uₘₑₐₙ^{T2}. In an embodiment, different aggregated embeddings based on the amount of time that has passed since the interactions may be used to alter the size of the set of job opportunity content items presented to a user. For example, the size of the set of job opportunity content items similar to an older aggregated embedding may be smaller than the size of the set of job opportunity content items similar to a newer aggregated embedding. This may be beneficial to the entity since more recent entity session activity is likely to be more relevant to the entity than activity that is older. In another embodiment, aggregated embeddings based on entity session activity and the amount of time that has passed since interactions may be associated with different weight factors. For example, older aggregated embeddings may have smaller weight factors associated, while newer aggregated embeddings may have larger weight factors associated. The weight factors may be applied to scores associated with embeddings for identified job opportunity content items for recommendation, such that scores for embeddings for job opportunity content items associated with newer aggregated embeddings are increased by the associated weight factors, while scores for embeddings for job opportunity content items associated with older aggregated embeddings are decreased based on the associated weight factors.

### Embedding Scoring Service

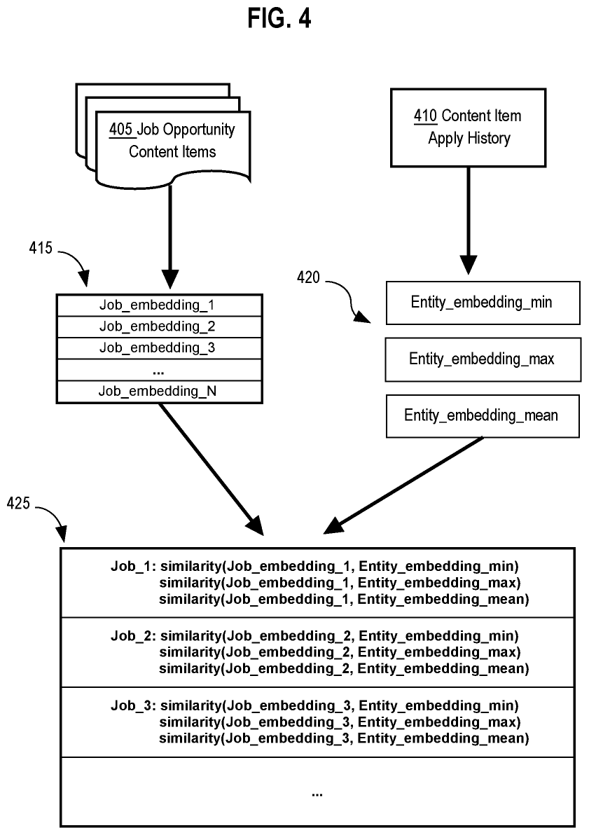

The embedding scoring service 225 is implemented to determine similarities between job opportunity embeddings and aggregated embeddings that represent an entity's ideal job opportunity. In an embodiment, the embedding scoring service 225 may compare the aggregated embeddings to available job opportunity content items for the purpose of determining a set of job opportunity content items to recommend to the entity. FIG. 4 illustrates determining similarities between entity-based aggregated embeddings and available job opportunity content item embeddings. In FIG. 4, job opportunity content items 405 represent available job opportunity content items retrieved from the content item data store 230. Content item apply history 410 represents job opportunity content items that a specific entity interacted with during one or more entity sessions. For example, the content item apply history may represent job opportunity content items for which the entity applied. In other examples, the content item apply history 410 may also include job opportunity content items for which the entity viewed or otherwise followed up. Job embeddings 415 represent job embeddings corresponding to each job opportunity in the job opportunity content items 405. The job embeddings 415 may be provided to the embedding scoring service 225 by the machine-learned model embedding service 215. Entity embeddings 420 represents aggregated embeddings generated by the aggregated embedding generation service 220. For example, the entity embeddings may include entity_embedding_min which represents an aggregated embedding generated from minimum pooling, entity_embedding_max which represents an aggregated embedding generated from maximum pooling, and entity_embedding_mean which represents an aggregated embedding generated from mean pooling.

Similarity function 425 represents the process by which the embedding scoring service 225 calculates a similarity score between each of the job opportunities represented by job embedding 415 and each of the entity embeddings 420. For example, the embedding scoring service 225 calculates three similarity scores for job_1, a first similarity score with respect to the entity_embedding_min, a second similarity score with respect to the entity_embedding_max, and a third similarity score with respect to the entity_embedding_mean. In an embodiment, the embedding scoring service 225 may calculate a single similarity score based on a single statistical pooling technique or multiple similarity scores based on each of the statistical pooling techniques calculated by the aggregated embedding scoring service 225.

In an embodiment, the embedding scoring service 225 may calculate a similarity score between an embedding of a job opportunity content item and an aggregated embedding by determining the distance between the embedding of the job opportunity content item and the aggregated embedding within the vector space of the machine-learned model. Referring back to the example described in FIG. 3, similar job opportunities tend to be clustered close together, such that the vector distance between two very similar job opportunities would be small, while the vector distance between two very different job opportunities would be large.

In one embodiment, the embedding scoring service 225 may calculate a Euclidean distance value between the embedding of a job opportunity content item and the aggregated embedding. If the two embeddings are clustered near each other in the vector space then the Euclidean distance value would be small. In another embodiment, the embedding scoring service 225 may calculate a cosine similarity, which is a measure of similarity between two non-zero vectors within the vector space. In yet another embodiment, the embedding scoring service 225 may calculate a Jaccard similarity between the feature values within embeddings for job opportunity content item and the aggregated embedding. Jaccard similarity is a statistical technique used to measure similarity between two finite sets of values defined as the size of the intersection divided by the size of the union of the sets of values.

In an embodiment, upon determining similarity scores for job opportunity content items for entities, the embedding scoring service 225 may store the scored embeddings in the embedding data store 240. The stored embedding scores may then be retrieved by the content item recommendation system 205 in response to receiving a request for job opportunity content items, for a specific entity, by the content delivery system 120. The content item recommendation system 205 may rank and/or select a subset of job opportunity content items based upon their assigned similarity scores. For example, for entity John Doe, the content item recommendation system 205 may retrieve the top 20 job opportunity content items based upon their assigned similarity score, where the top 20 job opportunity content items are job opportunities that are most similar to John Doe's job apply history, search history, and other interaction history with previously presented job opportunities. Ranking of job opportunity content items may be based on their assigned score, where the job opportunity content item with the highest score is ranked first. In an embodiment, in cases where multiple aggregated embeddings are used to identify different sets of job opportunity content items, averages may be calculated for each of the sets of job opportunity content items such that the set of job opportunity content items with the highest average score is ranked about other sets that have lower scores. Job opportunity content items, within each set, may then be ranked and sorted according to their individual score. In another embodiment, median scores for each of the multiple sets of job opportunity content items may be determined and used to rank each of the sets of job opportunity content items.

### Processing Overview

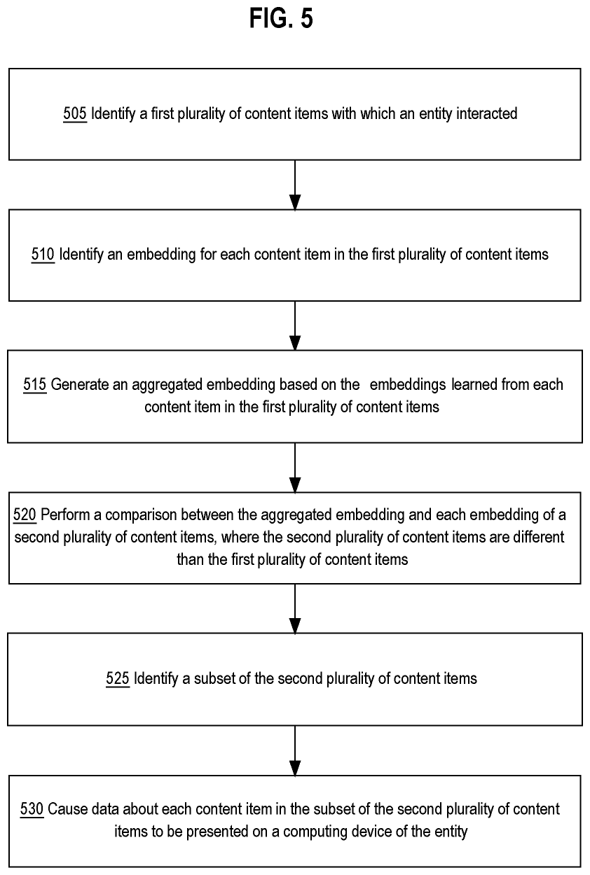

FIG. 5 depicts an example flowchart for generating an aggregated embedding representing an ideal job opportunity for an entity and identifying a set of content items, for presentation, that are similar to the ideal job opportunity for the entity, in an embodiment. Process 500 may be performed by a single program or multiple programs. The operations of the process as shown in FIG. 5 may be implemented using processor-executable instructions that are stored in computer memory. For purposes of providing a clear example, the operations of FIG. 5 are described as performed by the content item recommendation system 205 and its components. For the purposes of clarity process 500 is described in terms of a single entity. In an embodiment, process 500 may be scheduled to initiate at a specific time or day. For instance, process 500 may be part of a nightly offline process, a weekly process, or a monthly process. In other embodiment, process 500 may by initiated in response to a request for job opportunity content items, such as an entity selecting or navigating to a job board section within the content management system.

In operation 505, process 500 identifies a first plurality of content items with which an entity interacted. In an embodiment, the entity activity identification service 210 may retrieve, from the user interaction database 126, entity interaction data describing interactions performed during previous entity sessions. For example, if the entity is Jane Doe, then the entity activity identification service 210 may retrieve interaction data for Jane Doe's entity sessions and may identify a first plurality of job opportunity content items with which Jane Doe interacted. Interactions with job opportunity content items may include, but are not limited to, selecting a job opportunity content item, applying for a job opportunity represented by a specific job opportunity content item, or dismissing a specific job opportunity content item. Each of the interactions with job opportunity content items may be used to evaluate whether the specific entity likes or dislikes a job opportunity for the purposes of determining an ideal job opportunity for the entity.

In operation 510, process 500 identifies an embedding for each content item in the first plurality of content items. In an embodiment, the machine-learned model embedding service 215, receives, as input, a job opportunity content item and determines its corresponding embedding using the machine-learned model. The output of the machine-learned model is an embedding. As described, the machine-learned model represents a model that maps job opportunity content items, based on their corresponding job opportunity features, in a vector space to generate the representative embedding. In an embodiment, the machine-learned model embedding service 215 provides corresponding embeddings for each of the job opportunity content items in the first plurality of content items.

In operation 515, process 500 generates an aggregated embedding based on the embeddings learned from each content item in the first plurality of content items. In an embodiment, the aggregated embedding generation service 220 generates an aggregated embedding using statistical pooling techniques to aggregate each of the feature values in the embeddings corresponding to the first plurality of content items. In one embodiment, the aggregated embedding generation service 220 may perform mean pooling to generate a mean aggregated embedding that represents an ideal job opportunity based upon the embeddings corresponding to the first plurality of content items.

In another embodiment, the aggregated embedding generation service 220 may perform minimum pooling to generate a minimum aggregated embedding that represents an ideal job opportunity based upon outlier feature values in the embeddings corresponding to the first plurality of content items. In yet another embodiment, the aggregated embedding generation service 220 may perform maximum pooling to generate a maximum aggregated embedding that represents an ideal job opportunity based upon outlier feature values in the embeddings corresponding to the first plurality of content items. The aggregated embedding generation service 220 may perform one or more statistical pooling techniques to generate one or more aggregated embeddings.

In operation 520, process 500 performs a comparison between the aggregated embedding and each embedding of a second plurality of content items, where the second plurality of content items are different than the first plurality of content items. In an embodiment, the embedding scoring service 225 may retrieve a second plurality of job opportunity content items from the content item data store 230. In an embodiment, the embedding scoring service 225 may preselect a subset of job opportunity content items based upon a particular industry, job type, or entity preference. In other embodiments, the embedding scoring service 225 may select all job opportunity content items from the content item data store 230. The embedding scoring service 225 may then request corresponding embeddings, from the machine-learned model embedding service 215, for each of the job opportunity content items in the second plurality of job opportunity content items. In another example, the machine-learned model embedding service 215 may have previously stored embeddings corresponding to job opportunity content items within the embedding data store 240 and then then embedding scoring service 225 may retrieve the embeddings from the embedding data store 240. The embedding scoring service 225 may then perform a comparison between the aggregated embedding, representing the ideal job opportunity for the entity, and each of the embeddings corresponding to the second plurality of job opportunity content items. The comparison may be performed by generating a similarity score between the aggregated embedding and the embedding of a job opportunity content item, where the similarity score is a Euclidean distance value between the two embeddings. In other embodiments, the similarity score may be a cosine similarity value. In yet other embodiments, the similarity score may be based on a Jaccard similarity between features in the aggregated embedding and the job opportunity content item.

The embedding scoring service 225 may calculate similarity scores for each pair of embeddings between the aggregated embeddings and the second plurality of job opportunity embeddings. The embedding scoring service 225 may then store the similarity scores for each pair of embeddings between the aggregated embeddings and the second plurality of job opportunity embeddings in the embedding data store 240 for later retrieval on-demand.

In operation 525, process 500 identifies a subset of the second plurality of content items. In an embodiment, the content item recommendation system 205 may identify a subset of job opportunity content items that are sufficiently similar to an aggregated embedding for the entity. Determining whether a job opportunity content item is sufficiently similar to an aggregated embedding may be based upon the corresponding similarity score of a job opportunity content item being below a similarity threshold. A similarity threshold may represent a maximum distance, within the vector space, between two embeddings and still be considered similar. For example, if the similarity scores are based on Euclidean distance values, then the similarity threshold may represent a maximum Euclidean distance value that two embeddings must be below in order to be considered similar. The subset of the second plurality of job opportunity content items may represent job opportunity content items with corresponding embeddings that have Euclidean-based similarity scores that are below the similarity threshold.

In another embodiment, the subset of job opportunity content items may be based on a specified number of job opportunity content items that have the lowest similarity scores. For example, if the subset is capped at 20 job opportunity content items, then the job opportunity content items that have embeddings with the lowest similarity scores would be selected to be in the subset, where low similarity scores mean that the distance between the job opportunity content item embedding and the entity's aggregated embedding is small, thus the aggregated embedding and the job opportunity content item embedding are similar.

In operation 530, process 500 causes data about each content item in the subset of the second plurality of content items to be presented on a computing device of the entity. In an embodiment, the content item recommendation system 205 may transmit to the content delivery system 120 the subset of the second plurality of content items. The content delivery system 120 may then cause data from the subset of the second plurality of content items to be presented on client device 142 operated by the entity. For example, the content delivery system 120 may present content items in the subset of the second plurality of content items within a job feed on the client device 142. In another example, the content delivery system 120 may present summaries of the subset of the second plurality of content items as part of search results presented on the client device 142.

In an embodiment, the content delivery system 120 may present the data for the subset of the second plurality of content items to the client device 142 as part of a larger set of data of job opportunity content items, where the other job opportunity content items are selected using other selection methods. For example, the content delivery system 120 may select another set of job opportunity content items based upon static profile attributes of the entity as well as data representing the subset of the second plurality of job opportunity content items.

### Cold Start

The content item recommendation system 205 is implemented to select job opportunity content items based upon an entity's session activity and interactions with other job opportunity content items. However, if the entity is new to the content management system and has not previously initiated an entity session, then there would be no interaction history with previously presented job opportunity content items. In this scenario, the content item recommendation system 205 may fall back to identifying job opportunity content items based upon a similarity between job opportunity embeddings and an entity profile based embedding. For instance, if the machine-learned model is a two-tower embedding model where entity profile attributes are mapped to entity embeddings, then the entity embedding corresponding to the new entity may be used as a substitute for the aggregated embedding. The embedding scoring service 225 may then retrieve the second plurality of job opportunity content items and may calculate similarity scores between the entity embedding and corresponding embeddings for the second plurality of job opportunity content items. Once the new entity has initiated an entity session and has interacted with job opportunity content items, then the content item recommendation system 205 may, for subsequent job opportunity requests, use interaction data from the latest entity session of the new entity.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

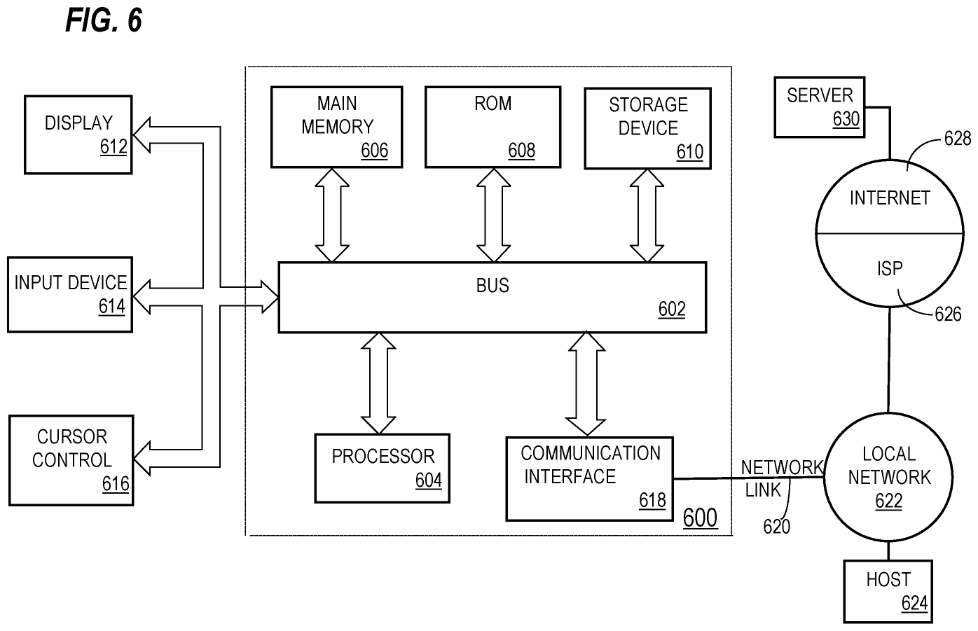

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a first plurality of content items with which an entity interacted;
for each content item in the first plurality of content items, identifying an embedding that was learned for said each content item;
generating an aggregated embedding based on the embedding that was learned for each content item in the first plurality of content items;
for each content item in a second plurality of content items that are different than the first plurality of content items, performing a comparison between the aggregated embedding and an embedding of said each content item;
based on the comparison between the aggregated embedding and the embedding of each content item in the second plurality of content items, identifying a subset of the second plurality of content items; and
causing data about each content item in the subset to be presented on a computing device of the entity;
wherein the method is performed by one or more computing devices.

2. The method of claim 1, further comprising:
determining that the entity performed an interaction with respect to a first content item, wherein the interaction comprises one or more of selecting the first content item, apply to a job associated with the first content item, or dismissing the first content item; and
adding the first content item to the first plurality of content items based on the interaction.

3. The method of claim 1, wherein identifying the embedding that was learned for said each content item, comprises, for each content item in the first plurality of content items:
providing, as input, to a machine-learned model, a set of features associated with said content item, wherein the machine-learned model is implemented to map the set of features of said content item to an embedding within a vector space;
receiving, from the machine-learned model, the embedding for said content item, wherein the embedding is a vector representing the set of features for said content item; and
wherein the set of features for said content item comprise one or more of a job title, one or more job skills, an associated company, an associated company size, an associated company location, a required experience, or a required degree.

4. The method of claim 1, wherein generating the aggregated embedding based on the embedding that was learned for each content item in the first plurality of content items comprises generating the aggregated embedding using mean pooling to aggregate each of the embeddings associated with the content items in the first plurality of content items.

5. The method of claim 1, wherein generating the aggregated embedding based on the embedding that was learned for each content item in the first plurality of content items comprises generating the aggregated embedding using maximum pooling to aggregate each of the embeddings associated with the content items in the first plurality of content items.

6. The method of claim 1, wherein generating the aggregated embedding based on the embedding that was learned for each content item in the first plurality of content items comprises generating the aggregated embedding using minimum pooling to aggregate each of the embeddings associated with the content items in the first plurality of content items.

7. The method of claim 1, wherein performing the comparison between the aggregated embedding and the embedding of said each content item in the second plurality of content items comprises:
identifying a particular embedding for said each content item;
calculating a vector distance value between the aggregated embedding and the particular embedding; and
assigning a score to the particular embedding based upon the vector distance value between the aggregated embedding and the particular embedding.

8. The method of claim 7, wherein identifying the subset of the second plurality of content items comprises identifying the subset of the second plurality of content items that have assigned scores below a similarity threshold value that defines a maximum distance between two similar embeddings.

9. The method of claim 1, wherein performing the comparison between the aggregated embedding and each embedding of the second plurality of content items comprises:
for each particular content item in the second plurality of content items,
identifying a particular embedding for the particular content item;
calculating a cosine similarity value between the aggregated embedding and the particular embedding; and
assigning a score to the particular embedding based upon the cosine similarity value between the aggregated embedding and the particular embedding.

10. The method of claim 1, wherein the first plurality of content items and the second plurality of content items are content items associated with a job opportunity.

11. The method of claim 1, further comprising:
generating an entity profile embedding, for a second entity, based upon entity profile attributes of the second entity, wherein the second entity is a new entity that has not previously interacted with content items;
for each content item in a third plurality of content items, performing a comparison between the entity profile embedding and an embedding of said each content item in the third plurality of content items;
based on the comparison between the entity profile embedding and the embedding of each content item in the third plurality of content items, identifying a subset of the third plurality of content items; and
causing data about each content item in the subset of the third plurality of content items to be presented on second computing device of the second entity.

12. A computer program product comprising:
one or more non-transitory computer-readable storage media comprising instructions which, when executed by one or more processors, cause:
identifying a first plurality of content items with which an entity interacted;
for each content item in the first plurality of content items, identifying an embedding that was learned for said each content item;
generating an aggregated embedding based on the embedding that was learned for each content item in the first plurality of content items;
for each content item in a second plurality of content items that are different than the first plurality of content items, performing a comparison between the aggregated embedding and an embedding of said each content item;
based on the comparison between the aggregated embedding and the embedding of each content item in the second plurality of content items, identifying a subset of the second plurality of content items; and
causing data about each content item in the subset to be presented on a computing device of the entity.

13. The computer program product of claim 12, wherein the one or more non-transitory computer-readable storage media comprises further instructions which, when executed by the one or more processors, cause:
determining that the entity performed an interaction with respect to a first content item, wherein the interaction comprises one or more of selecting the first content item, apply to a job associated with the first content item, or dismissing the first content item; and
adding the first content item to the first plurality of content items based on the interaction.

14. The computer program product of claim 12, wherein identifying the embedding that was learned for said each content item, comprises, for each content item in the first plurality of content items:
providing, as input, to a machine-learned model, a set of features associated with said content item, wherein the machine-learned model is implemented to map the set of features of said content item to an embedding within a vector space;
receiving, from the machine-learned model, the embedding for said content item, wherein the embedding is a vector representing the set of features for said content item; and
wherein the set of features for said content item comprise one or more of a job title, one or more job skills, an associated company, an associated company size, an associated company location, a required experience, or a required degree.

15. The computer program product of claim 12, wherein generating the aggregated embedding based on the embedding that was learned for each content item in the first plurality of content items comprises generating the aggregated embedding using mean pooling to aggregate each of the embeddings associated with the content items in the first plurality of content items.

16. The computer program product of claim 12, wherein generating the aggregated embedding based on the embedding that was learned for each content item in the first plurality of content items comprises generating the aggregated embedding using maximum pooling to aggregate each of the embeddings associated with the content items in the first plurality of content items.

17. The computer program product of claim 12, wherein generating the aggregated embedding based on the embedding that was learned for each content item in the first plurality of content items comprises generating the aggregated embedding using minimum pooling to aggregate each of the embeddings associated with the content items in the first plurality of content items.

18. The computer program product of claim 12, wherein performing the comparison between the aggregated embedding and the embedding of said each content item in the second plurality of content items comprises:
identifying a particular embedding for said each content item;
calculating a vector distance value between the aggregated embedding and the particular embedding; and
assigning a score to the particular embedding based upon the vector distance value between the aggregated embedding and the particular embedding.

19. The computer program product of claim 18, wherein identifying the subset of the second plurality of content items comprises identifying the subset of the second plurality of content items that have assigned scores below a similarity threshold value that defines a maximum distance between two similar embeddings.

20. The computer program product of claim 12, wherein performing the comparison between the aggregated embedding and each embedding of the second plurality of content items comprises:
for each particular content item in the second plurality of content items,
identifying a particular embedding for the particular content item;
calculating a cosine similarity value between the aggregated embedding and the particular embedding; and
assigning a score to the particular embedding based upon the cosine similarity value between the aggregated embedding and the particular embedding.
